(19) United States
(12) Patent Application Publication
(10) Pub. No.: US 2010/0220876 A1
(43) Pub. Date: Sep. 2, 2010

(54) THERMO-ACOUSTIC TRANSDUCERS

(75) Inventors: Ronaldus Maria Aarts, Eindhoven (NL); Daniel Willem Elisabeth Schobben, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/993,071

(22) PCT Filed: Jun. 20, 2006
(86) PCT No.: PCT/IB06/51974

§ 371 Date: Dec. 19, 2007

(30) Foreign Application Priority Data
Jun. 24, 2005 (EP) 05105648.9

(51) Int. Cl. H04R 25/00

(52) U.S. Cl. 381/164

(57) ABSTRACT

A thermo-acoustic transducer device (8) comprises a substantially hollow body (10) in which a thermo-acoustic element (11) is accommodated, and a heating control unit (2) coupled to the thermo-acoustic element (11) for controlling the temperature gradient of the element. The heating control unit (2) is arranged for being controlled by a control signal (Sₘ). The device further comprises a modulation unit (3) coupled to the heating control unit (2) for producing the control signal in response to an audio signal (Sᵢ). The modulation unit (3) may comprise a band pass filter unit (31) for selecting a frequency band of the audio signal (Sᵢ), a detector unit (32) for detecting the envelope of the band-pass filtered audio signal so as to produce the control signal (Sₘ), and a low-pass filter unit (33) for low-pass filtering the control signal (Sₘ).

The present invention relates to thermo-acoustic transducers. More in particular, the present invention relates to a thereto-acoustic transducer comprising a substantially hollow body in which a temperature gradient element, typically a so-called thereto-acoustic stack, is accommodated.

It is well known to use thermo-acoustic principles to generate or enhance sound. U.S. Pat. No. 5,369,625 (Gabrielson), for example, discloses a submersible acoustic generator. The generator comprises a tubular resonator, open at its lower end and closed at its upper end, in which a so-called thereto-acoustic stack is located. A pair of heat exchangers, one of which is heated by a chemical fuel while the other one is cooled by the surrounding water, generate a temperature gradient in the stack. This temperature gradient allows high-amplitude oscillations to be produced in the resonator.

Typical thermo-acoustic generators are capable of producing monotonous sound only, that is, sound having a single frequency, at a substantially fixed sound volume. This has limited the application of thereto-acoustic devices in audio systems. Still, it would be highly desirable to use thermo-acoustic devices in audio systems as they have no moving parts, which constitutes a significant advantage over conventional loudspeakers.

It is an object of the present invention to overcome these problems of the Prior Art and, particularly, to provide a thereto-acoustic transducer device which may be used advantageously in audio systems.

Accordingly, the present invention provides a thermo-acoustic transducer device, comprising a substantially hollow body in which at least one thermo-acoustic element is accommodated, and a heating control unit coupled to the thermo-acoustic element for controlling the temperature gradient of the element, wherein the heating control unit is arranged for being controlled by a control signal, and wherein the device further comprises a modulation unit coupled to the heating control unit for producing the control signal in response to an audio signal.

By providing a heating control unit which can be controlled by a control signal, the temperature gradient of the thermo-acoustic element and hence the acoustic energy (sound volume) produced by the thermo-acoustic device can be controlled. By providing a modulation unit for producing the control signal in response to an audio signal, the heating of the thermo-acoustic element, and hence the sound volume produced, is controlled by the input audio signal. Accordingly, an amplitude modulated audio signal is obtained, the modulation being determined by the input audio signal. Such a device is particularly, but not exclusively, useful for reproducing bass sound.

It is noted that the thermo-acoustic element may be a thermo-acoustic stack known per se, which stack may consist of a set of substantially parallel, spaced plates, preferably arranged in planes parallel to the length of the hollow body. The material of the stack can be porous, although metal may also be used. In a typical embodiment, the thermo-acoustic element comprises one or more heating elements which are in thermal contact with one end of the spaced plates.

It is further noted that more than one thermo-acoustic element may be present in the device or unit of the present invention, for example two or three thermo-acoustic elements could be provided.

In a preferred embodiment, the modulation unit comprises a band pass filter unit for selecting a frequency band of the audio signal, and a detector unit for detecting the envelope of the band-pass filtered audio signal so as to produce the control signal. The band pass filter allows a relevant frequency band, such as the bass band, to be selected. The envelope detector produces a suitable modulation signal which is subsequently used as heating control signal to modulate the sound level.

In an advantageous embodiment, the modulation unit further comprises a low-pass filter unit for low-pass filtering the control signal. This ensures that any undesired frequency components, which may be introduced by the envelope detector, are substantially removed from the control signal.

It is noted that International Patent Application WO2005/027569 (Philips) discloses an audio arrangement in which a single frequency driving signal is produced for a transducer designed to operate at its resonance frequency. The transducer of this known arrangement is a conventional loudspeaker, thermo-acoustic devices are not disclosed in said document.

The present invention further provides a method of driving a thermo-acoustic transducer device comprising a substantially hollow body in which at least one thermo-acoustic element is accommodated, and a heating control unit coupled to the thermo-acoustic element for controlling the temperature gradient of the element; the method comprising the steps of:
producing a control signal in response to an audio signal, and
controlling the heating control unit by the control signal.

Advantageously, the method of the present invention may further comprise the steps of:
selecting a frequency band of the audio signal, and
detecting the envelope of the band-pass filtered audio signal so as to produce the control signal.

The present invention also provides an audio system, comprising an audio amplifier and a thermo-acoustic transducer device as defined above. The audio system may further comprise one or more loudspeakers and a sound source, such as a DVD player, a radio tuner, an internet terminal, and/or an MP3 or AAC player.

The present invention will further be explained below with reference to exemplary embodiments illustrated in the accompanying drawings, in which:

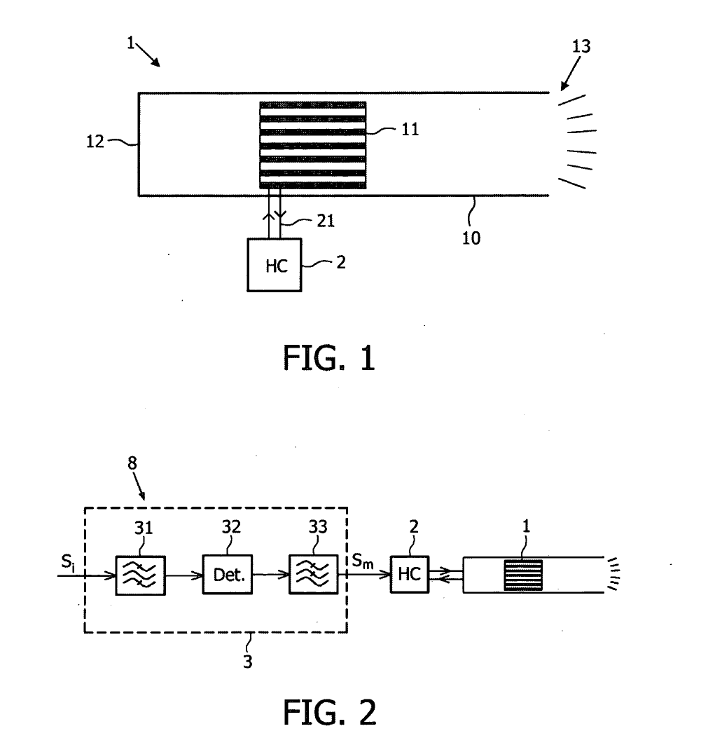

FIG. 1 schematically shows a thereto-acoustic transducer unit according to the Prior Art.

FIG. 2 schematically shows a first embodiment of a thermo-acoustic transducer device according to the present invention.

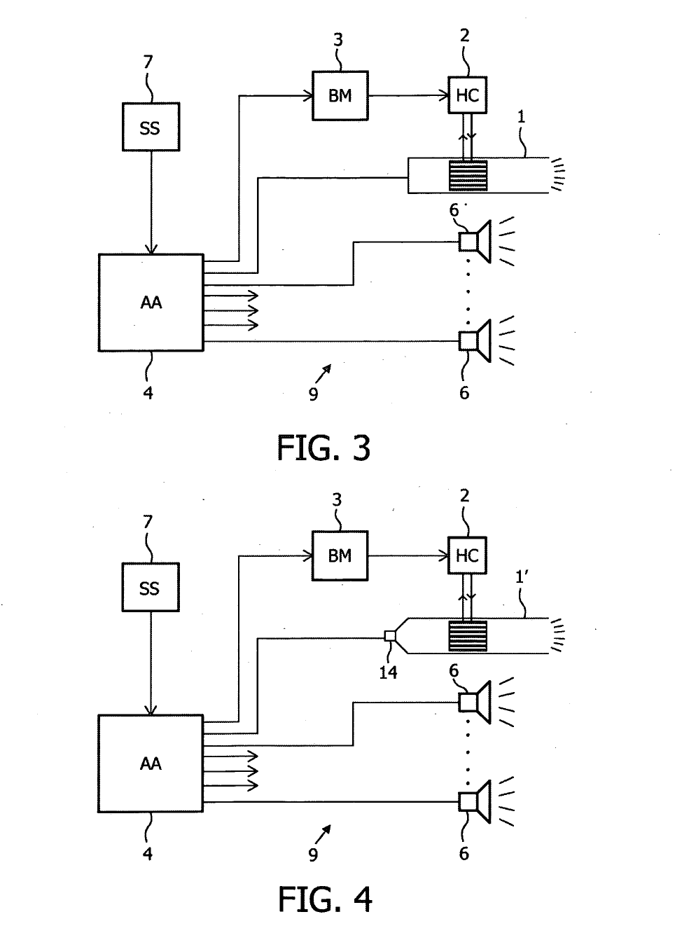

FIG. 3 schematically shows a first embodiment of an audio system according to the present invention.

FIG. 4 schematically shows a second embodiment of an audio system according to the present invention.

The thermo-acoustic transducer unit 1 according to the Prior Art which is shown by way of example in FIG. 1 comprises a substantially hollow body 10 in which a thermo-acoustic element 11 is accommodated, and a heating control unit 2 coupled to the thermo-acoustic element 11 for controlling its temperature gradient. The hollow body 10 may be tubular. In the example shown, the body 10 has a closed end 12 and an open end 13.

The thermo-acoustic element 11 typically comprises a stack of spaced plates and one or more heating elements, one end of each plate being thermally coupled to the heating elements so as to provide local heating. The other end of each plate is typically not heated, or may even be cooled, so as to produce a temperature gradient in the stack of plates. As a result of this temperature gradient, a standing wave will be produced in the interior of the body 10: the air within the body 10 will resonate, the required energy being provided by the thermo-acoustic element 11. By setting the heating current produced by the heating control unit 2, the temperature gradient of the element 11 can be set at a suitable, fixed value. The thermo-acoustic transducer unit 1 of FIG. 1 may be used instead of a conventional loudspeaker to produce monotones.

The thereto-acoustic transducer device 8 according to the present invention which is shown merely by way of non-limiting example in FIG. 2 comprises a thermo-acoustic transducer unit 1, a heat control unit 2 and a modulation unit 3.

The thermo-acoustic transducer unit 1 used in the device 8 of FIG. 2 may be substantially identical to the thermo-acoustic transducer unit 1 of FIG. 1 and may also comprise a substantially hollow body 10 in which at least one thermo-acoustic element 11 is accommodated, and a heating control unit 2 which is electrically coupled to the thermo-acoustic element 11 for controlling its temperature gradient.

In the example shown, the hollow body (10 in FIG. 1) of the thereto-acoustic transducer unit 1 has a closed end and an open end. The hollow body may be tubular, having a substantially round or oval cross-section, although other cross-sections may also be used, such as rectangular, square, triangular, hexagonal and octagonal.

The thereto-acoustic element (11 in FIG. 1) may comprise a conventional thermo-acoustic stack as disclosed in, for example, U.S. Pat. No. 5,369,625 mentioned above, the entire contents of which are herewith incorporated in this document. A heating control unit 2 is electrically coupled to the thermo-acoustic element 11 for controlling its temperature gradient. A heat sink (not shown) may be provided to cool the opposite end of the thermo-acoustic element 11.

In accordance with the present invention, the heating control unit 2 is arranged for being controlled by a control signal Sₘ, and the device additionally comprises a modulation unit 3 coupled to the heating control unit 2 for producing the control signal in response to an audio signal Sᵢ. By allowing the heating control unit 2 to be controlled by an external signal, the temperature gradient of the thereto-acoustic element 11 can be easily varied. By providing a modulation unit for deriving the control signal Sₘ from the audio signal Sᵢ, an audio signal controlled temperature gradient is achieved, resulting in an audio signal controlled sound level.

The modulation unit 3 shown in FIG. 2 comprises a band pass filter 31, an envelope detector 32 and a low pass filter 33. A band pass filter 31 receives an input audio signal Sᵢ and selects a desired frequency band of this audio signal, for example the bass band, although higher frequency bands may be selected instead. The filtered audio signal is passed to the envelope detector 32, which produces an envelope signal representing the envelope of the filtered audio signal. This envelope signal is then low pass filtered by the (optional) low pass filter 33 to produce a modulation signal Sₘ. This modulation signal is then received as a control signal by the heating control unit 2. As a result, the modulation (or control) signal Sₘ will modulate the temperature gradient in the thereto-acoustic element, and therefore also the sound level produced by the thermo-acoustic unit 1, in accordance with the input audio signal Sᵢ. In other words, the sound level produced by the thereto-acoustic unit 1 will vary with the input audio signal Sᵢ.

The thereto-acoustic transducer device 8 of the present invention is very suitable for a reproducing bass sound, for example in the frequency range from 20 to 80 Hz, although the present invention is not so limited and other frequency ranges could also be reproduced. The device 8 effectively maps the selected frequency range onto the resonance frequency of the thermo-acoustic unit 1. It is therefore preferred that this resonance frequency lies within the frequency range selected by the band pass filter 31, although this is not essential.

When used for reproducing bass frequencies, the device 8 of the present invention is particularly suitable for replacing conventional subwoofers in audio systems. The device 8 of the present invention may also be used in the subsonic range.

A particularly suitable application of the present invention is fire alarms and other acoustic alarm apparatus where sound having a high sound level must be produced. The thermo-acoustic transducer device of the present invention allows a compact yet powerful acoustic alarm to be provided.

In the embodiment of FIG. 2, all heat produced in the thereto-acoustic element (11 in FIG. 1) of the thermo-acoustic transducer unit 1 is produced electrically, controlled by the heat control unit 2. It is also possible that part of the heat required is produced by other means, for example by the power amplifier of an audio system. In that case, heat pipes may connect the power amplifier and the thereto-acoustic element.

An exemplary embodiment of an audio system according to the present invention is schematically illustrated in FIG. 3. The audio system 9 of the present invention comprises a thermo-acoustic transducer unit 1 including a heat control unit 2, a bass modulation (BM) unit 3, an audio amplifier (AA) 4, loudspeakers 6 and a sound source (SS) 7. The thermo-acoustic transducer unit 1 may be a Prior Art unit as shown in FIG. 1. The bass modulation unit 3 may correspond to the modulation unit 3 in FIG. 2 and is in this embodiment designed for mapping bass frequencies onto the frequency of the thermo-acoustic transducer unit 1. The bass modulation unit 3 receives an (amplified) audio signal from the audio amplifier 4. Loudspeakers 6, which may be conventional loudspeakers designed for producing mid- and high frequency sound, also receive amplified audio signals from the audio amplifier 4. The audio signals originate from a sound source 7, which may be a CD player, a DVD player, a computer, an internet terminal, an AAC or MP3 player, or any other suitable sound source. In the audio system 9 of FIG. 3, the thermo-acoustic transducer unit 1 allows a very efficient bass sound production.

The audio system of the present invention may comprise further components which are not shown in the Figures for the sake of clarity. For example, cross-over filters may be arranged between the audio amplifier 4 and the loudspeakers 6.

An alternative embodiment of the audio system according to the present invention is illustrated in FIG. 4. This embodiment of the audio system 9 comprises the same components as the embodiment of FIG. 3. However, the thermo-acoustic transducer unit 1 has been modified to include a loudspeaker further mentioned (acoustic) speaker 14. This acoustic speaker 14 terminates one end of the hollow body (10 in FIG. 1) and is coupled to the audio amplifier 4.

This modified thereto-acoustic unit 1′ is capable of producing a wider range of frequencies. The bass modulator 3 and the heating control 2 still control the sound level produced by the unit 1′. The sound produced by the speaker 14 may thus be amplitude modulated by the thereto-acoustic element (11 in FIG. 1). In some embodiments, the acoustic speaker may reproduce a first frequency range of an audio signal while the bass modulation unit produces a modulating (control) signal based on another frequency range of the same audio signal. For example, a first frequency range of 200 to 1000 Hz could be amplitude modulated in dependence of a second frequency range of 40 to 100 Hz, so as to enhance the bass perception of the audio signal.

The present invention is based upon the insight that a thereto-acoustic transducer may advantageously be used to render bass sound, in particular when a bass range is mapped onto a very narrow frequency band.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents. In this document, a thermo-acoustic (transducer) device is meant to comprise at least one thermo-acoustic (transducer) unit.

It will be understood by those skilled in the art that the present invention is not limited to the embodiments illustrated above and that many modifications and additions may be made without departing from the scope of the invention as defined in the appending claims.

1. A thermo-acoustic transducer device (8), comprising:
a substantially hollow body (10) in which at least one thereto-acoustic element (11) is accommodated,
a heating control unit (2) coupled to the at least one thermo-acoustic element (11) for controlling the temperature gradient of the element, the heating control unit (2) being arranged for being controlled by a control signal (Sₘ), and
a modulation unit (3) coupled to the heating control unit (2) for producing the control signal (Sₘ) in response to an audio signal (Sᵢ).

2. The transducer device according to claim 1, wherein the modulation unit (3) comprises:
a band pass filter unit (31) for selecting a frequency band of the audio signal (Sᵢ), and
a detector unit (32) for detecting the envelope of the band-pass filtered audio signal so as to produce the control signal (Sₘ).

3. The transducer device according to claim 2, wherein the modulation unit (3) further comprises:
a low-pass filter unit (33) for low-pass filtering the control signal (Sₘ).

4. An audio system (9), comprising:
an audio amplifier (4), and
the thermo-acoustic transducer device (8) according to claim 1, 2 or 3.

5. The audio system according to claim 4, further comprising a sound source (7) and/or at least one loudspeaker (6).

6. The audio system according to claim 4, wherein the thermo-acoustic transducer device (8) comprises an acoustic speaker (14).

7. An alarm apparatus, comprising the thermo-acoustic transducer device (8) according to claim 1, 2 or 3.

8. A method of driving a thereto-acoustic transducer device (8) comprising:
a substantially hollow body (10) in which at least one thermo-acoustic element (11) is accommodated, and
a heating control unit (2) coupled to the thermo-acoustic element (11) for controlling the temperature gradient of the element,
the method comprising the steps of:
producing a control signal (Sₘ) in response to an audio signal (Sᵢ), and
controlling the heating control unit (2) by the control signal (Sₘ).

9. The method according to claim 8, further comprising the steps of:
selecting a frequency band of the audio signal (Sᵢ), and
detecting the envelope of the band-pass filtered audio signal so as to produce the control signal (Sₘ).
